(19) United States
(12) Patent Application Publication
(10) Pub. No.: US 2003/0194597 A1
(43) Pub. Date: Oct. 16, 2003

(54) Contact plate for an electrochemical cell, process and an injection mold for producing the contact plate and contact plate assembly

(76) Inventors: Albin Von Ganski, Buttenwiesen (DE); Thomas Hagenbach, Basel (CH); Alwin Muller, Wurzburg (DE)

Correspondence Address: LERNER AND GREENBERG, P.A., POST OFFICE BOX 2480, HOLLYWOOD, FL, 33022-2480, US

(21) Appl. No.: 10/413,038

(22) Filed: Apr. 14, 2003

(30) Foreign Application Priority Data
Apr. 14, 2002 (DE) 102 16 306.5

(51) Int. Cl. H01M 8/02

(52) U.S. Cl. 429/38; 429/241; 429/26

(57) ABSTRACT

A contact plate for electrochemical cells, formed of a graphite-thermoplastic composite with a graphite percentage of at least 80% by mass, containing functional elements necessary for the transport of reaction media and creating electrical contact with electrodes, has a fluid mechanical construction such that it can be produced in an injection molding process without secondary working. The production of edge areas of non-conductive material surrounding the contact plate, and seals, can be integrated into the injection molding process through the use of multi-component technology so that the entire plate including the edge area and seals can be produced in one injection mold.

### BACKGROUND OF THE INVENTION

### FIELD OF THE INVENTION

The invention relates to a contact plate for electrochemical cells. More particularly, the invention relates to a contact plate of a graphite-plastic composite material for electrochemical cells, in particular fuel cells. The contact plate with structures required to transport reaction media and ensure electrical contact of electrodes, optionally with a seal or a peripheral area and a seal of non-conductive plastic, is constructed in such a way that it can be produced by an injection molding process. The invention also relates to a process and an injection mold for producing the contact plate as well as to a contact plate assembly.

Fuel cells are devices for direct conversion of chemical energy into electrical energy. A single fuel cell (see FIG. 1) is formed of two electrodes, an anode 2 and a cathode 3, which are separated from each other physically by an electrolytic layer e.g. a proton-conducting polymer membrane 4. The anode 2, the cathode 3 and the membrane 4 together form a membrane electrode assembly (MEA) 5. A fuel, e.g. hydrogen or methanol, is electrochemically oxidized at the anode. The released electrons flow through an external circuit to the cathode. Then, an oxidation agent e.g. oxygen is reduced upon reception of the electrons. Catalysts 6 are provided on interfaces between the electrode and the electrolyte to accelerate the electrode reactions.

Frequently, a multiplicity of fuel cells is combined in a cell stack to achieve the required performance for practical applications. The cells stacked one upon or behind another are held together by non-illustrated longitudinal bolts. The “stack” is terminated by end plates before the first and after the last cell.

Normally, the cells within a stack are connected electrically in series but parallel in relation to media transport. An electrical contact between successive cells is created by bipolar plates (BPP) 7. The reaction media are supplied and discharged through transport paths which cross the stack in a stacking direction i.e. successive bipolar plates BPP 7 and membrane electrode assemblies MEA 5 contain aligned openings for a fuel supply 8 and a fuel discharge 9 and for an oxidation agent supply 10 and an oxidation agent discharge 11.

In order to supply the individual electrodes with the reaction media, distribution structures with flow paths 17, e.g. channels, are recessed into the surface of a basic body 7′ of the bipolar plates BPP 7.

A media distribution structure 12 on the anode side of the bipolar plates BPP 7 serves for distribution of fuel over the surface of the anode 2. A media distribution structure 13 on the cathode side serves for distribution of an oxidation agent over the surface of the cathode 3. The media distribution structures 12, 13 are connected through inlets 15 and outlets 14 with the corresponding media supply paths 8, 10 and media discharge paths 9, 11. Protruding elements or projections 16 e.g. lands on the surface of the bipolar plates BPP 7 create electronic contact to the adjacent electrodes. The structure of the plate surface must therefore fulfill two tasks: distribution of the reaction medium and electrical contact with the adjacent electrodes, and is therefore also referred to below as a contact and distribution structure.

Mixing of the different reaction media must be prevented. Therefore, a seal is applied against the oxidation agent supply path 10 and the discharge path 11 on an anode side A of each bipolar plate BPP 7. A seal is also applied against the fuel supply path 8 and the discharge path 9 on a cathode side K. Grooves are recessed into the plate surface (see FIGS. 2A and 2D) in order to hold the seals. The bipolar plate BPP 7 can be constructed as a combination of an anode-side partial plate 7a and a cathode-side partial plate 7b. Abutting surfaces of the two partial bipolar plates 7a and 7b can enclose a coolant distribution structure (not shown in FIG. 1). This construction is referred to below as a cooling plate assembly. In order to provide for the supply and discharge of the coolant, further transport paths crossing the stack are provided and the transport paths of the coolant and reaction media must also be sealed against each other.

The end plates, the bipolar plates and the plates with the coolant distribution structure (cooling plates) are referred to below collectively as contact plates for electrochemical cells.

Due to the complex function of the contact plates, high requirements apply to the materials being used: electrical conductivity, impermeability to reaction medium (function as a separator), thermal and mechanical stability under the operating conditions of the fuel cells (up to 120° C. for polymer membrane fuel cells), chemical resistance to the reaction media and corrosion resistance. The material must also be easy to form and process for the production of the complex flow structures. Suitable materials include graphite-plastic composites i.e. plastics filled to a very high level with conductive graphite or carbon particles. Conventionally, those composites are compressed under high pressure and high temperature into plate blanks and in a second work process are given a media distribution structure by CNC milling, for example. Structured plates can also be produced in one work process through the use of a suitably formed mold. However, in those processes, the cycle times are relatively long.

In order to reduce cycle time and unit costs, a production process is required which is suitable for automated mass production, e.g. the injection molding process. However, it is difficult to adapt that process for the production of contact plates to electrochemical cells of graphite-plastic composites. Due to the high level of filling (>70 wt %), the flowing ability of those composites is considerably lower than that of unfilled or low-filled plastics. Attempts have therefore been made firstly to better adapt the material properties of the composite to the requirements of the injection molding process, and secondly to modify the production technology according to the properties of the composite. Material optimizations include the use of extremely low viscosity thermoplastics e.g. LCP (U.S. Pat. No. 6,180,275), attrition of the polymer particles after cooling with liquid nitrogen (International Publication No. WO 00/44005, corresponding to U.S. Pat. No. 6,379,795), the addition of additives influencing flowing ability which suppress the segregation of components (U.S. Pat. No. 6,180,275) and minimizing the particle size, specific surface and aspect ratio of the conductive particles (U.S. Pat. No. 6,180,275, European Patent Application No. 1 061 597 A2, International Publication No. WO99/49530). Process technology optimization includes, for example, improving the mixing of components (International Publication No. WO 00/44005, corresponding to U.S. Pat. No. 6,379,795), increasing the injection pressure to 13×10⁶ to 500×10⁶ N/m² (U.S. Pat. No. 6,180,275), increasing the injection speed to at least 500 mm/s and increasing the nozzle temperature by 40 to 80 K above the melt temperature of the material (International Publication No. WO 00/30203, corresponding to U.S. patent application Publication No. 2002/039,675A1 and U.S. Pat. No. 6,180,275).

However, in both optimization approaches the variation possibilities are limited. Firstly, there are technological limits to changes in process parameters, e.g. an increase in injection pressure, etc.. Secondly, the high requirements for conductivity allow no substantial reduction in the graphite proportion. Plastics suitable for the production of injection molding composites are often relatively costly (LCP) or thermosetting plastics must be used (e.g. vinylester as in U.S. Pat. No. 6,180,275) which, because of their hardening and crosslinking processes, require longer cycle times than thermoplastics. According to U.S. patent application Publication No. 2001/004,9046 A1, structured plates can be produced in injection molding without substantial secondary processing from a starting material of at least one unsaturated vinylester, at least one unsaturated monomer for crosslinking of the unsaturated vinylester, a crosslinking initiator and preferably a mass proportion of at least 65% conductive particles. However, typical cycle times for typical plate sizes of 2.54 to 50.8 cm×2.54 to 50.8 cm (1 to 20 inches×1 to 20 inches) lie in the range of 1 to 2 minutes. A further disadvantage of polyester-based thermosetting plastics is their sensitivity to hydrolysis. It is therefore desirable to replace the plastic components of the composite with an easily processable, sufficiently hydrolysis-resistant and economically conventional thermoplastic, for example polypropylene.

A further option, in addition to the limited material and mechanical optimization described above, is optimization of the plate construction with regard to process engineering possibilities of the injection molding process with high-filled plastics. Irrespective of the introduction of the injection molding process there are, in fact, structures of contact plates in which the use of the difficult-to-process conductive material is reduced to the area of the plate which is necessary for function. Function elements with complex structures such as openings for the media supply paths and media discharge paths and branches to the flow channels on the plate surface are relocated into a non-conductive periphery (e.g. a frame). Frame constructions of plastic with integrated media supply and discharge paths have been known for some time for fuel cells with liquid electrolyte (see e.g. U.S. Pat. No. 3,278,336). The conductive plate is, for example, glued (European Patent EP 0 620 609 B1) or (manually) pressed (U.S. Pat. No. 5,879,826) into the frame. U.S. Pat. No. 5,514,487 describes plastic components called “edge manifold plates”, which are placed at the side of the bipolar plate or BPP but in contrast to a frame do not surround the bipolar plate or BPP completely. Those manifold plates contain manifold openings for the media supply and discharge and at least one channel for effecting fluid communication between the manifold opening and the fuel cell to which the manifold plate is attached. Conductive bipolar plates or BPP and non-conductive manifold plates in that case are two individual components which must be produced separately and then joined, for example with adhesive. As adhesives age, the structural integrity of such a joint is ambiguous in fuel cell operation over a long period.

The injection molding process is sometimes used in order to provide for the production of such components of unfilled plastic. For example, a conductive plate of corrosion-resistant metal or carbon is surrounded by a molded plastic frame containing through-holes for media supply and discharge paths (International Publication No. WO 97/50139). A conductive plate with a molded plastic frame can be made from a graphite plastic composite by hot pressing or injection stamping of a premold (blank) (International Publication No. WO 01/80339).

The application of seals to bipolar plates or BPP in injection molding is also known (German Pat. DE 199 10 487 C1, corresponding to U.S. Pat. No. 6,436,568). However, the bipolar plate or BPP itself is not made in injection molding but rather by using the conventional processes described above.

### SUMMARY OF THE INVENTION

It is accordingly an object of the invention to provide a contact plate for an electrochemical cell, a process and an injection mold for producing the contact plate and a contact plate assembly, which overcome the hereinafore-mentioned disadvantages of the heretofore-known devices and methods of this general type and which allow production from a composite of a low-cost conventional thermoplastic with a mass fraction of at least 80% conductive filler in one work process in one mold by the injection molding process. The contact plate must have the structural elements necessary for transport of reaction media and electrical contacting of the electrodes. However, the shape of the elements must not hinder the material flow in the injection mold, so that complete filling of the cavity is achieved. This object is achieved by the fluid mechanical construction with the features according to the invention. The contact plate according to the invention corresponds, on one hand, to the process engineering requirements for injection molding of high-filled plastics and, on the other hand, fulfils all requirements arising from use in fuel cells with equivalent quality to a plate produced in a conventional process with a longer cycle time.

A further object of the invention is to provide structures for a gate which allow reliable filling of the injection mold without deterioration in the surface structure of the BPP according to the invention.

A further aspect of the invention is to facilitate ejection of the filled mold and to construct the ejectors of the injection mold in such a way that during the ejection process the structural integrity of the BPP is not damaged.

Another object of the invention is to restrict the proportion of costly conductive material, which is difficult to process, to the area necessary for the function of the contact plate, and to make areas which need not necessarily be electrically conductive from a graphite-free plastic. This embodiment of the contact plate contains areas of graphite-filled plastic and areas of graphite-free plastic and in contrast to the conventional state of the art is produced completely in one mold by injection molding in multi-component technology. A stable and reliable bond is provided between the areas made from filled plastic and those of graphite-free plastic for this embodiment of the contact plate.

The invention further includes a contact plate, in the production process of which the application of seals is integrated in the injection molding process.

With the foregoing and other objects in view there is provided, in accordance with the invention, in an electrochemical cell having electrodes, a contact plate, comprising an injection molded basic body having a through plane conductivity of at least 20 S/cm. The basic body is formed of a plastic-graphite composite having a thermoplastic plastic component and a mass percentage of graphite of at least 70%. The basic body has openings formed therein for supply paths and discharge paths of media reacting at the electrodes. The basic body has at least one plate surface, a media distribution structure recessed in the plate surface defining flow paths for distribution of the medium reacting at adjacent electrodes, and a contact structure protruding from the media distribution structure with contact structure elements for providing electrical contact with an electrode adjacent the basic body. Connections are provided between the media distribution structure on the plate surface and the supply path and discharge path for the media reacting at the adjacent electrodes. The flow paths in the media distribution structure have base surfaces, wall surfaces and first transitions from the base surfaces to the wall surfaces, and all of the first transitions are rounded. The contact structure elements have surfaces in contact with the adjacent electrodes, defining second transitions from the wall surfaces of the flow paths to the surfaces of the contact structure elements, and all of the second transitions are rounded.

With the objects of the invention in view, there is also provided, in an electrochemical cell having electrodes, a contact plate, comprising a basic body. The basic body includes a conductive area having a through plane conductivity of at least 20 S/cm and being formed of a plastic-graphite composite. The basic body also includes a non-conductive edge area adjacent the conductive area. The basic body may have openings formed therein for supply paths and discharge paths for media reacting at the electrodes. The basic body may have a plate surface, a media distribution structure on the plate surface, and connections between the media distribution structure, the supply path and the discharge path for the media reacting at an electrode adjacent the plate. The basic body may have sealing grooves formed therein. The basic body may also have an element fulfilling a sealing function. The element is integrated in the non-conductive edge area, and the basic body including the conductive area and the non-conductive edge area is injection molded in one mold by multi-component technology.

With the objects of the invention in view, various process and injection molds for producing the contact plate and assemblies of contact plates, are also provided.

Other features which are considered as characteristic for the invention are set forth in the appended claims.

Although the invention is illustrated and described herein as embodied in a contact plate for an electrochemical cell, a process and an injection mold for producing the contact plate and a contact plate assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, exploded, perspective view of a section of a fuel cell stack;

FIG. 2A is a fragmentary, perspective, sectional view of a bipolar plate with advantageous features of the invention;

FIG. 2B is an enlarged, fragmentary, cross-sectional view of an area IIb of FIG. 2A, with an advantageous feature of the invention;

FIG. 2C is a fragmentary, cross-sectional view of a flow channel without the features of the invention;

FIG. 2D is a fragmentary, cross-sectional view of a structure of a flow channel according to the invention, which is taken along a line IId-IId in FIG. 2A, in the direction of the arrows;

FIG. 3A is a perspective view showing various advantageous structures of a gate on a contact plate according to the invention;

FIG. 3B is a fragmentary, cross-sectional view of a sprue with a film gate, which is taken along a line IIIb-IIIb of FIG. 3A, in the direction of the arrows;

FIG. 3C is a fragmentary, cross-sectional view of a structure according to the invention for the sprue on a plate surface and for an auxiliary connection, which is taken along a line IIIc-IIIc in FIG. 3A, in the direction of the arrows;

FIG. 4 is a fragmentary, cross-sectional view of a configuration of ejection bevels (drafts), which is taken along a line IV-IV in FIG. 3A, in the direction of the arrows;

FIG. 5A is a top-plan view showing a positioning of ejector pins in sealing grooves and compressed air ejectors on channel bases and a position of a rectangular ejector;

FIG. 5B is a sectional view showing the positioning of ejector pins, compressed air ejectors and rectangular ejectors in a mold half, which is taken along a line Vb-Vb in FIG. 5A, in the direction of the arrows;

FIGS. 6A-D are plan views showing constructions of a contact plate with a peripheral area of non-conductive plastic;

FIG. 7A is a perspective view and FIGS. 7B-I are fragmentary, cross-sectional views, showing constructions of a connection between a conductive area of a graphite-plastic composite and an edge area of a graphite-free non-conductive plastic;

FIG. 8A is a top-plan view of a plastic frame for a bipolar plate or BPP with a sealing function;

FIG. 8B is a partial cross-sectional view, which is taken along a line VIIIb-VIIIb in FIG. 8A, in the direction of the arrows, showing several bipolar plates stacked above each other, the frames of which have a sealing function; and

FIG. 9 is a partial cross-sectional view of a function assembly according to FIG. 1, compiled into a packet with a seal and cooling channels.

### DESCRIPTION OF THE PREFERRED EMBODIMENTS

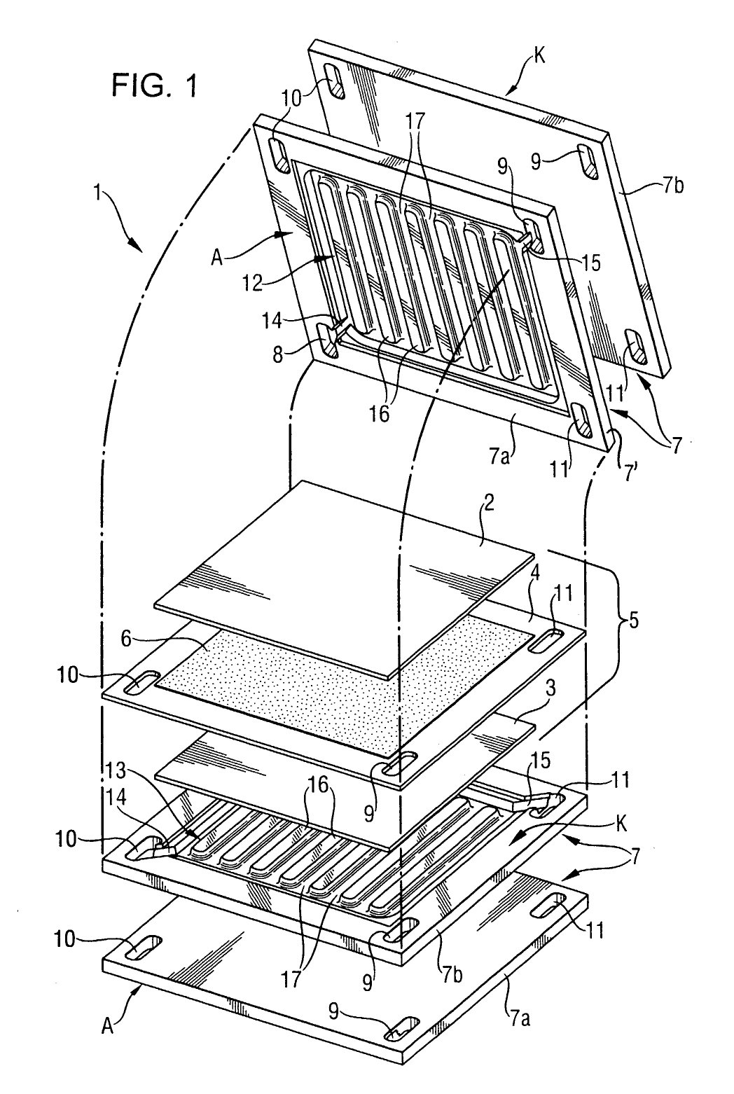

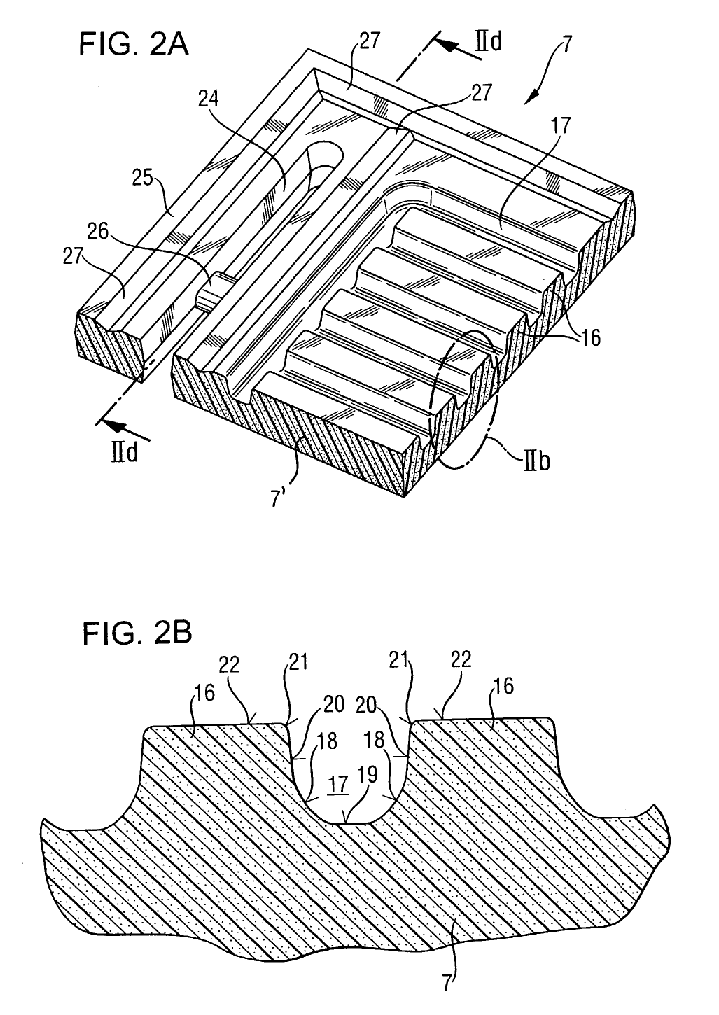

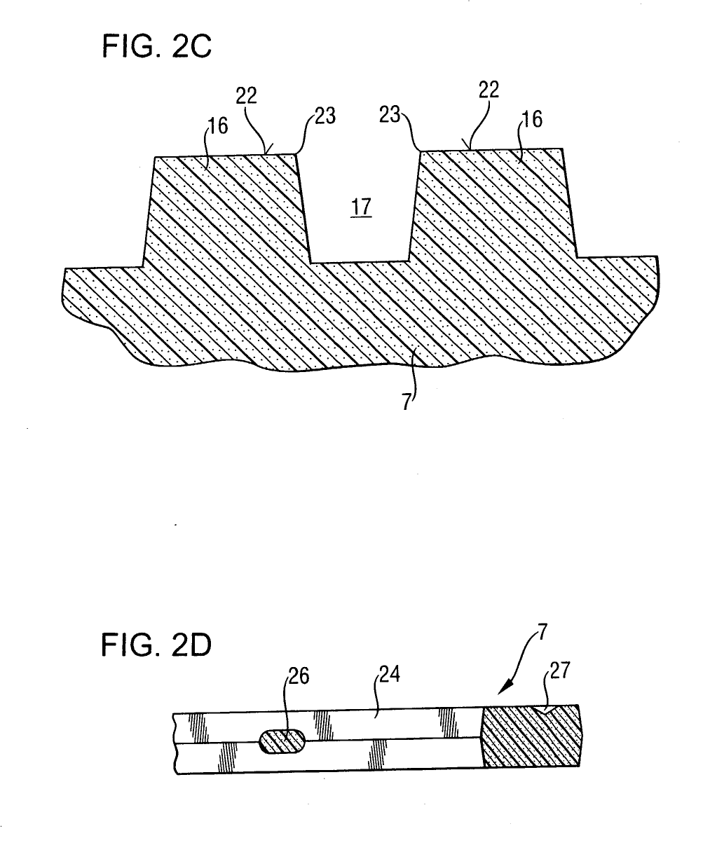

Referring now to the figures of the drawings in detail and first, particularly, to FIGS. 1 and 2A thereof, it is seen that a structure which defines flow paths or channels 17 required for an even distribution of reaction media is recessed into surfaces of a basic body 7′ of contact plates 7 facing electrodes 2, 3 between which a membrane 4 coated with a catalyst 6 is disposed in a membrane electrode assembly (MEA) 5 of a cell 1. This structure firstly includes recessed parts through which there is a flow of reaction media (referred to below as channels 17, but without restriction to a particular geometry), and secondly includes contact structure elements or projections 16 which protrude from the recesses of the media distribution structure and make contact with the electrodes (e.g. lands delimiting the channels or stand-alone projections with, for example, a rectangular base area, referred to below irrespective of their particular geometry as projections). A section of a bipolar contact plate 7 with a winding flow channel 17 is shown in FIG. 2A.

The projections 16 on the surface of the basic body 7′ of the bipolar plate 7 correspond in an injection mold to recesses in a cavity which must be completely filled. The filling of these recesses becomes more reliably guaranteed, the better their shape is adapted to the flow behavior of the material (fluid mechanical construction). Therefore, it is advantageous to produce all of the projections as being rounded as shown in FIGS. 2A and 2B. This applies both to first transitions 18 from a base 19 to wall surfaces 20 of the channels 17 and to transitions 21 from the channel wall surfaces 20 to surfaces (contact surfaces) 22 of projections 16. A rounding radius of 0.1 to 0.5 mm has proved advantageous. These roundings also facilitate ejection (removal of the plate from the mold). The rounding at the second transition 21 from the channel wall 20 to the surface 22 of the projection 16, in comparison with a projection 23 without a rounded transition (FIG. 2C), reduces an electrical contact surface to the electrode. However, this loss can, if necessary, be compensated by an initially larger surface structure of the projection 16. Such less finely divided structures in turn facilitate the complete filling of the mold. If, in contrast, no rounding is provided, due to incomplete filling of the cavity at the projections 16, undefined forms can result which in turn reduce the electrical contact to the electrode.

An alternative to this procedure is to construct the projections initially higher at least by the rounding radius than required in the stack and then to remove the additional material from the surface of the projection again so that a projection without roundings is achieved at the transitions from the channel walls 20 to the surface 22.

Rounding radii of between one-tenth and one-half of the width of the channel are suitable for the transitions 18 from the base 19 to the walls 20 of the channel 17. Round channel cross-sections are also fluidically advantageous since they counter the formation of dead volumes. This fluid mechanical advantage can at least partially compensate for the disadvantage that in order to guarantee electrical contact, the proportion of the contact surfaces 16 not available for media distribution in the media distribution and contact structure may have to be increased.

Furthermore, it is advantageous for filling the mold, for subsequent ejection of the workpiece and for media flow, to construct all of the direction changes of the channels 17 (corners, bends, branches) with a rounding.

Structures with openings 24 and constrictions are problematical from the aspect of mold filling. In the mold such structures act as constrictions in the filling cross-section and therefore as a flow brake for the material. Filling of the areas behind the opening in relation to the gate is particularly critical. Therefore, it is advantageous to initially provide additional flow webs in the mold which bridge the openings 24 and therefore contribute to the transport of material into the areas behind the openings. The minimum necessary thickness of the flow web is determined by the particle size of the conductive filler (0.3 mm for typical graphite particles). The maximum possible thickness of the flow web corresponds to the plate thickness. The flow webs in the filled mold are removed by injection stamping or core pulling technology in order to open an opening 24 completely. Alternatively, the flow webs can also be removed outside the injection mold. For this purpose, it is advantageous to integrate a punch processes following ejection into the entire process of plate production.

In the case of embodiments which in contrast to the relatively simple structure shown in FIG. 1 have very large openings 24 with long narrow peripheral webs 25, it is advantageous to leave the flow web as a support web 26. Openings for media supply paths 8, 10 and media discharge paths 9, 11 and longitudinal bolts are preferably disposed outside the conductive area provided for media distribution and electrical contacting of the electrode. Typically, the openings are located at the sides or corners of the plates and, to minimize material use and plate surface which is inactive for contacting and supply the media to the electrodes, are surrounded only by a narrow edge. This area of the plate is a mechanical weak spot. Therefore, it is advantageous to stabilize the edge web by providing a support web 26 which bridges the opening. In order, however, to guarantee an even media distribution over the entire opening cross-section, the support web 26 is preferably constructed to be thinner than the plate itself. For stability reasons, a minimum thickness of 0.8 mm is required for the support web. After passing the support web 26, the flows divided by the support web can recombine. The disturbance to the flow course by the support web must be kept slight and the formation of a dead volume behind the support web must be prevented. This is achieved by the rounded, streamlined cross-section of the support web 26 (FIG. 2D).

For stability reasons, it is best to place the support web 26 in the middle of the opening 24 of the basic body 7′. However, an eccentric configuration is also possible, provided this does not reduce stability. In order to provide for the homogeneity of the flow it is advantageous if the flow webs are disposed in such a way as to not be aligned in all successive plates but rather offset to each other.

If, through the use of flow webs, no adequate filling of the area behind the openings in relation to the gate can be achieved, alternatively the areas of the openings 24 in the mold can be filled completely and the required openings 24 then punched out. As with removal of the flow webs, punching of the openings can take place inside the mold through the use of core pulling or injection stamping, or in an integrated process step following ejection. Furthermore, a groove 27 can be provided in the plate surface to hold a seal.

The plate can have a media distribution and contact structure on both sides with the features described above. The channel depth is preferably selected in such a way that a residual wall thickness at the thinnest points of the plate is no less than 0.8 mm.

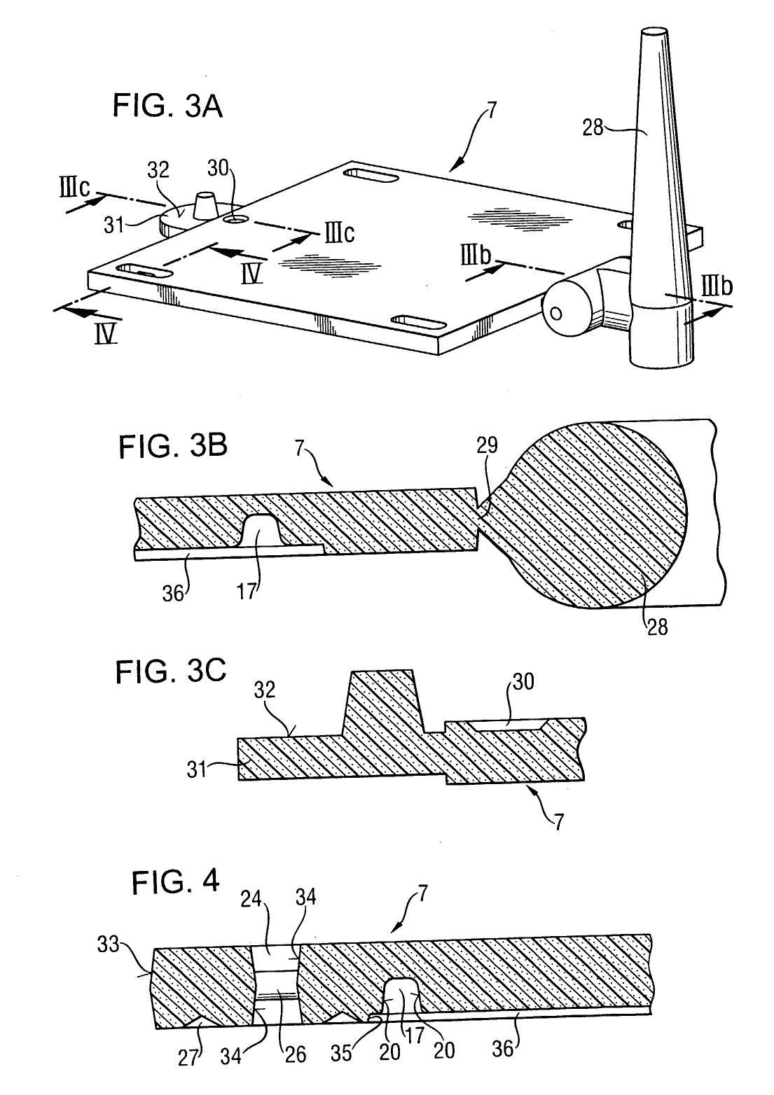

The structure of the gate (FIGS. 3A and 3B) also has a great influence on the filling of the mold. For better clarity, the media distribution structure has been omitted in FIG. 3A. It should be pointed out that the structures shown or not shown signify no restriction to a particular structure, since the aspects of the invention described below concerning the gate are independent of the special flow path structure and apply equally to bipolar plates, end plates and cooling plates i.e. contact plates in general.

A sprue 28 with a film gate 29 is suitable. The thickness of the film gate 29 can vary between a minimum determined by the particle size of the conductive filler (0.3 mm for typical graphite particles) and the thickness of the contact plate 7. The width of the gate can be selected in the range of a minimum of 5 mm up to the width of plate 7.

Furthermore, a hot channel system with one or more hot channel nozzles is suitable. Due to the lower flowability of the composite in comparison with unfilled plastics, the gate diameter of the hot channel nozzle must be greater than usual for injection molding of unfilled plastics, preferably at least 5 mm.

Non-illustrated gate channels with needle closures can be used in order to keep the gate marks as small as possible. The needle closures are controlled hydraulically. When gate channels with needle closures are used, the gate can be placed directly on the plate surface if the surface structure contains areas where sufficient area is available to position such a gate nozzle. Raised sprue marks in the form of protruding burrs have to be avoided. In order to achieve this, the opening of the gate channel in the mold is positioned in such a way that it is recessed into the surrounding plate surface of the plate to be formed in the mold (recess 30 in FIGS. 3A and 3C).

If neither sealing grooves nor projections offer sufficient space for a hot channel gate, small bulges 31 can be provided at the edges of the plate as auxiliary surfaces 32 for positioning of gate channels. These bulges or auxiliary connections 31 must be removed subsequently, if they cannot be integrated in the structure of the contact plate 7.

It is advantageous to control the injection nozzles in cascade in order to provide for even filling of the mold. This avoids several flow fronts existing simultaneously, which upon meeting could lead to flow seams and air inclusions.

The small thickness of the contact plate 7 (typically 1 to 3 mm) can cause ejection difficulties. In order to facilitate ejection, it is advantageous to provide all of the surfaces running across the plate plane with a slope of 0.5 to 30° relative to the vertical (ejection bevels or drafts seen in FIG. 4). Ejection bevels are provided both at front surfaces 33 of the contact plate and at walls 34 of the openings 24, the side walls 20 of the channels 17 and optionally at shoulders 35 on the plate surface. A recess 36 surrounded by the shoulder 35 in the plate surface serves for embedding of the respective electrodes 2 or 3.

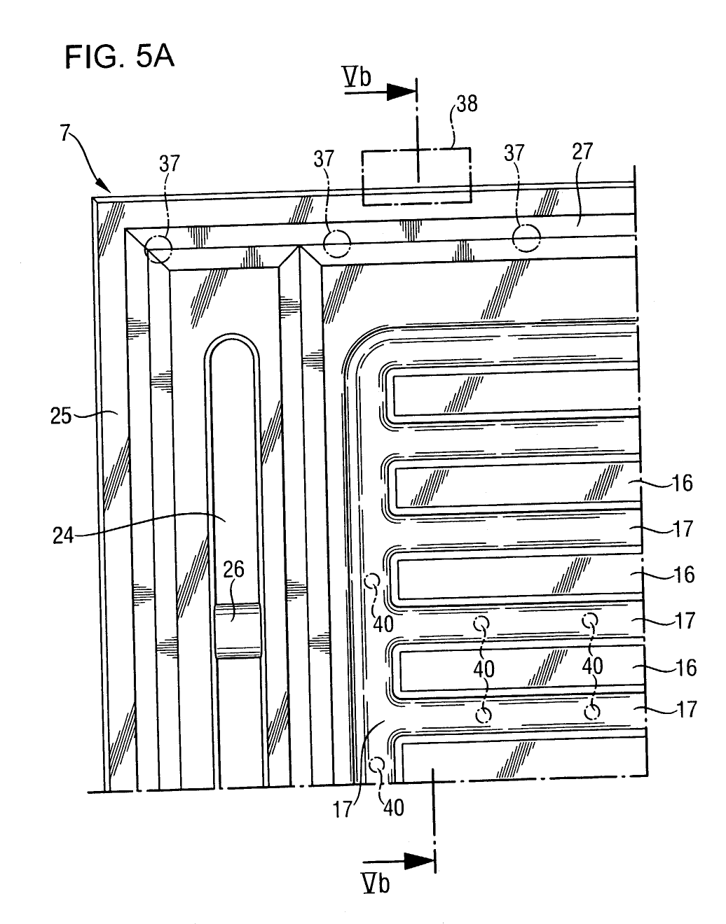

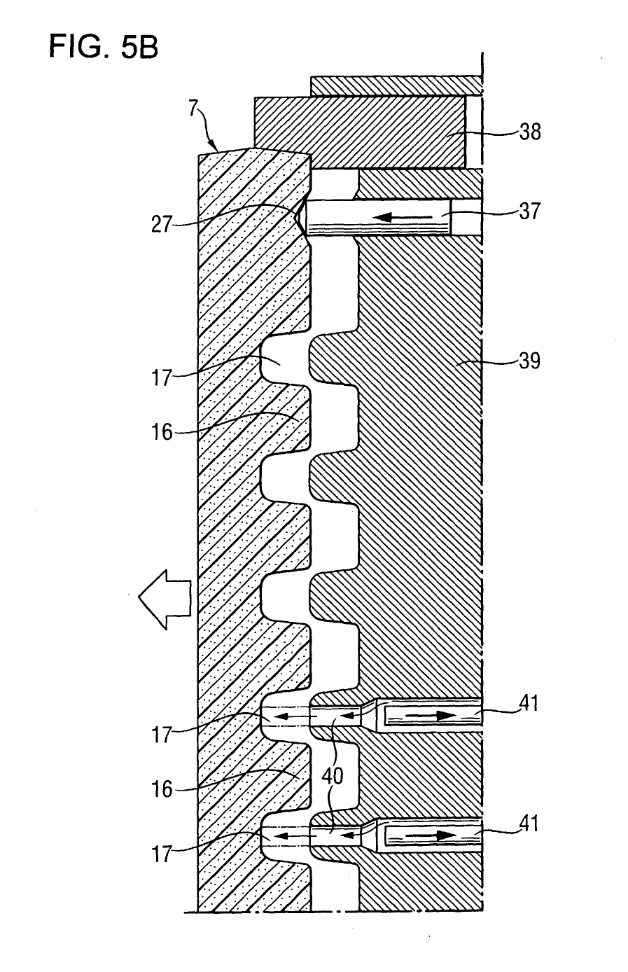

The structure of the contact plate 7 must not be damaged by the ejectors during removal from the mold. Conventional ejector pins 37 leave markings (imprints) on the surface of the workpiece. Such ejectors 37 are therefore preferably positioned in such a way that during the ejection process they push against the base of sealing grooves 27 (FIGS. 5A and 5B). Residual ejector markings there do not harm the function of the contact plate 7 since after filling of the sealing groove with a seal they are completely covered and sealed by the seal adapting to the shape of the groove.

Rectangular ejectors 38 (FIGS. 5A and 5B) are also suitable. These ejectors have reliefs and engage behind the contact plate 7 at the edges, so that the plate lies precisely in the reliefs of the ejectors 38. The reliefs are formed in such a way that they protrude at the front surface 33 of the workpiece over the parting surface of the two mold halves. Forced return ejectors are not required with this ejector structure.

Ejection through the use of compressed air is even more advantageous since in this case no markings remain. Therefore, compressed air channels 40 are provided in the mold 39 and are closed by pins 41. The pins 41 are retracted (back into the mold 39) and release the compressed air channels 40 during the ejection process. The compressed air channels are disposed in the mold in such a way that their openings lie on the base of the flow channels 17. The diameter of the pins and consequently the openings of the compressed air channels can be one-tenth to eight-tenths of the width of the flow channel 17.

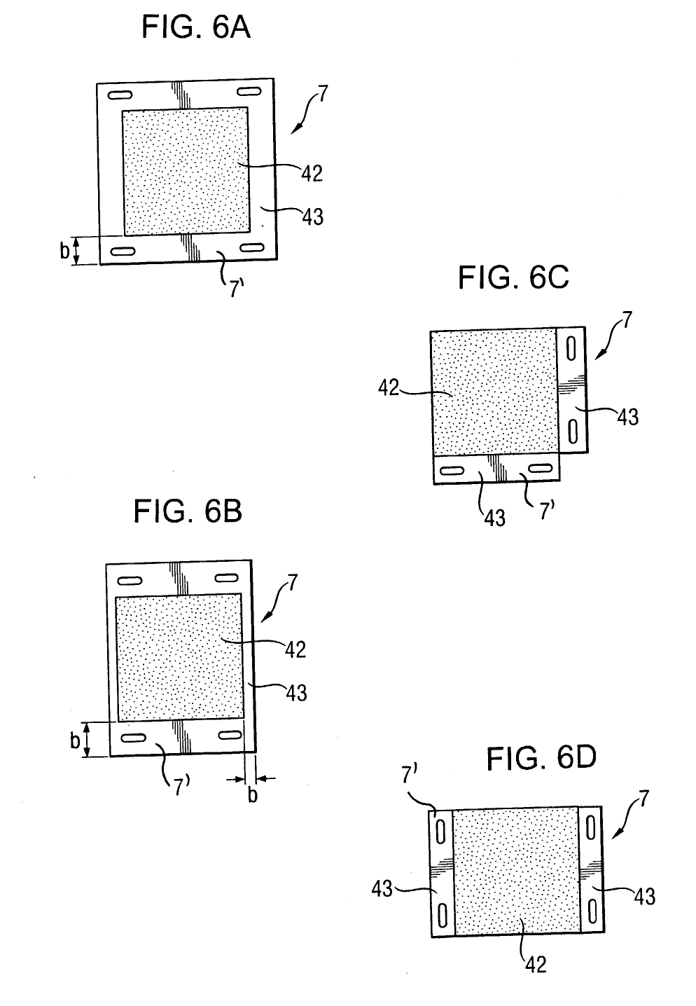

In order to reduce difficulties upon filling the complex structures of the plate with high viscosity material, it is advantageous to reduce the use of this material to the areas which must be conductive for functional reasons. In this embodiment the function elements not belonging to the contact structure, such as the openings for the media supply paths 8, 10 and media discharge paths 9, 11 and inlets and outlets 14, 15 branching therefrom to the channels 17 on the plate surface, can be placed in the periphery of the basic body 7′ of the plate 7 which is formed of a non-conductive material that is easier to process (FIGS. 6A to 6D).

In one embodiment, a conductive area 42 of the contact plate 7, the media distribution and contact structure of which has been omitted in FIGS. 6A to 6D for the sake of simplicity, is surrounded completely by a non-conductive plastic frame 43 (FIGS. 6A and 6B). As FIG. 6B shows, not all sides of this frame 43 need have the same width b. Thus the frame can be made wider at one or more edges of the conductive area to provide space for receiving function elements.

A further structural possibility is to attach the plastic frame or members 43 made of a non-conductive material, holding the function elements which do not need to be electrically conductive, to individual edges of the conductive area 42 of the contact plate 7. FIGS. 6C and 6D show some variants. In general this embodiment is formed by applying at least an area 43 of non-conductive material with any width b at one edge of the plate. However, the conductive area is not surrounded completely by the non-conductive edge area 43. According to the present invention a complete contact plate with conductive areas 42 of high-filled material and non-conductive areas 43 of graphite-free material is produced by injection molding in one mold (two-component process).

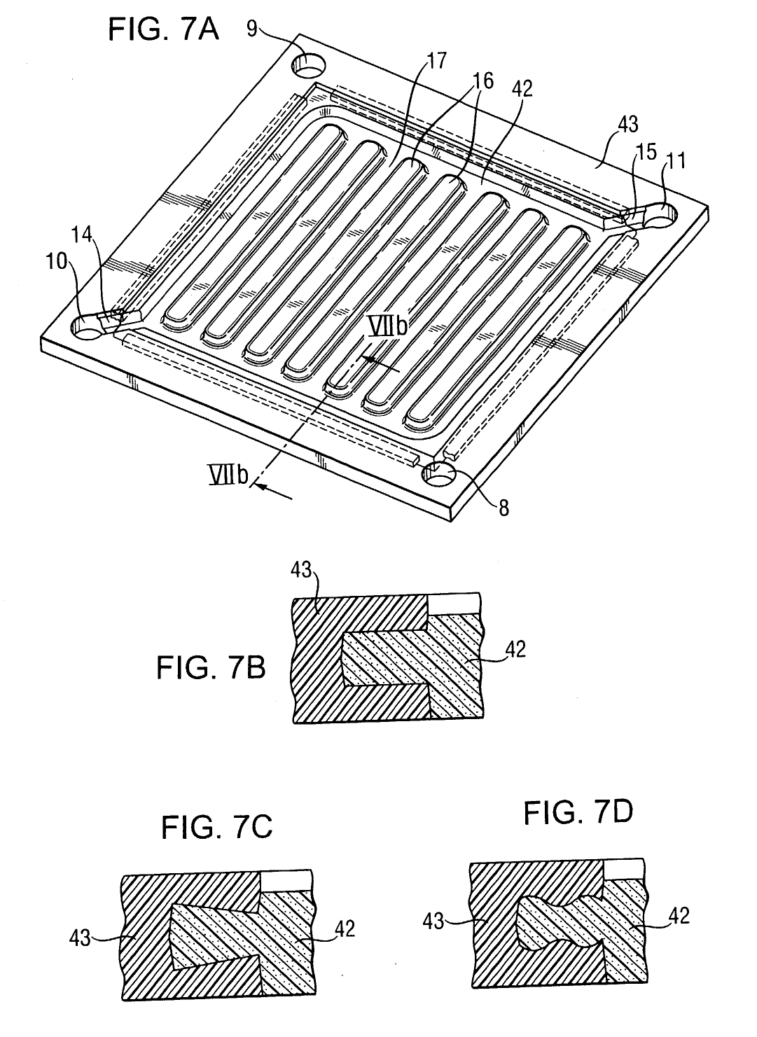

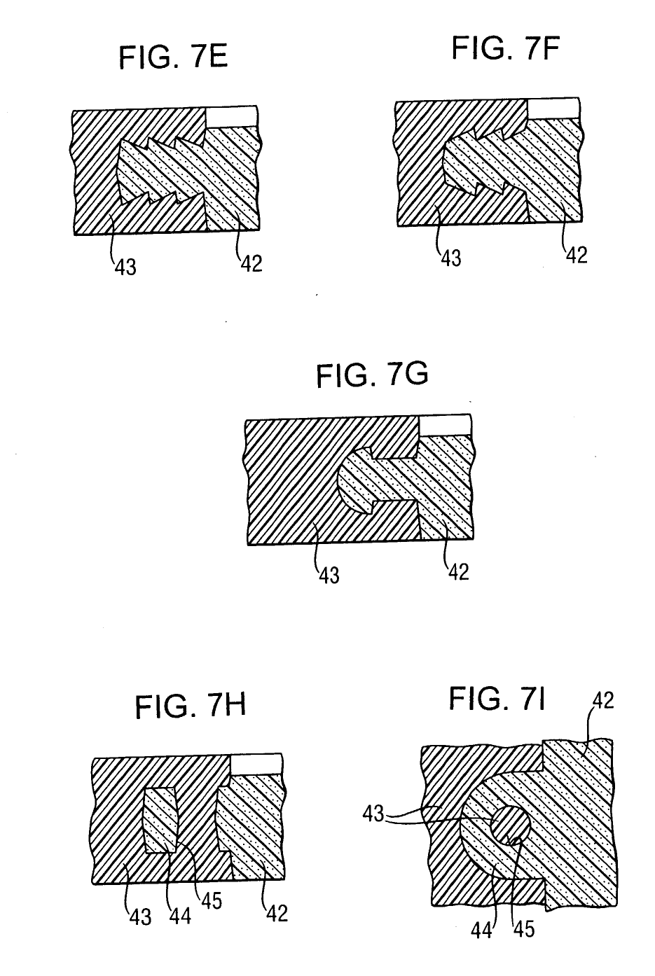

A stable and reliable bond must be produced between the contact plate areas 42 and 43 formed of different materials. For this purpose, according to the invention, structures are formed at a transition of the two materials which allow an interference connection, engagement, interlocking or intermeshing between the two areas (FIGS. 7A to 7I). The interference connection is shown in FIG. 7B. In order to achieve an additional form-locking connection, e.g. dovetail (FIG. 7C) or mushroom-like (FIG. 7G), structures or projections 44 with teeth, sawteeth (FIGS. 7E and 7F) or wave-like structures (FIG. 7d) are suitable. A further advantageous joint includes a projection 44 protruding into the non-conductive area 43 (FIGS. 7H and 7I) and containing a through bore 45. During injection molding of the adjacent area 43, the bore is filled with non-conductive (graphite-free) plastic so that the two materials intermesh inseparably. A form-locking connection is one which connects two elements together due to the shape of the elements themselves, as opposed to a force-locking connection which requires external force.

It is advantageous for the joining of the two materials that the plastic component, because of its greater flowability, is enriched at the surface of the structure during injection molding of graphite-plastic composites. This layer enriched with plastic improves the adhesion of the plastic sealing frame to the outer edges of the conductive plate.

The frame can be formed in such a way that it simultaneously fulfils a sealing function. It should be noted that the membrane 4 should not extend into the area of this sealing function, since in the present state of the art membrane materials are sensitive to mechanical stresses such as occur when compressing the sealing frames of successive cells.

Frames 43 of an elastomer are particularly advantageous for avoiding leaks between successive cells 1. This sealing frame 43 is constructed in such a way that in the compressed state it protrudes over the surface of the plate 7 flush with the electrodes 2 or 3 embedded in the recess 36 by half the thickness of the membrane 4 coated with the catalyst 6. The membrane electrode assembly or MEA 5 lying between the plates is sealingly surrounded in co-operation with the similarly structured sealing frame 43 of the following contact plate.

In the case of embodiments which do not provide a recess 36 for embedding the electrodes, the sealing frame 43 according to the invention, in a compressed state, protrudes above the contact structure elements 16 by half the thickness of the total membrane electrode assembly or MEA 5. This is done in order to surround the membrane electrode assembly or MEA 5 sealingly in co-operation with the similarly formed frame of the following contact plate 7.

In order to illustrate the comparative sizes in these embodiments, it should be noted that the membrane electrode assemblies or MEAs 5 which are conventional today are 100 to 200 μm thick and conventional electrodes 2, 3 are 200 to 300 μm thick.

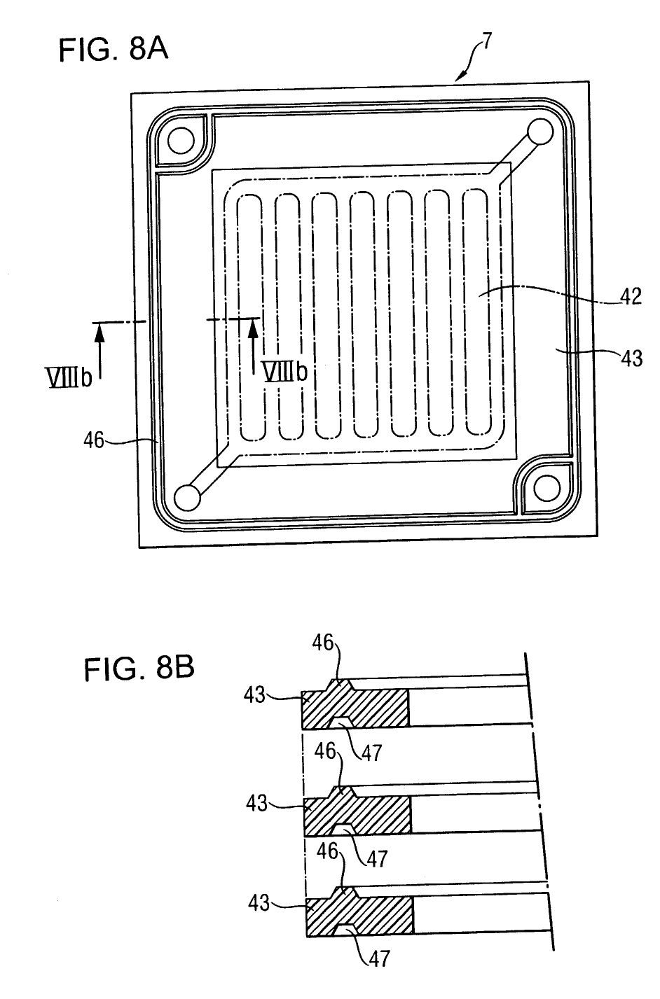

In addition, a frame of any plastic which is stable under the conditions of fuel cell use can be constructed in such a way that a sealing function is achieved (FIGS. 8A and 8B) in cooperation with the frame of adjacent cells. Therefore, the frame 43 is provided on the surface with a peripheral projection (tongue) 46 and on the rear surface with a corresponding groove 47, representing elements fulfilling a sealing function. When the longitudinal bolts of the stack are tightened, each tongue engages in the groove of the frame of the following plate (providing a tongue and groove joint) so that a tight seal is achieved. The cross-sections of the interlocking projections (tongues) and grooves are typically trough-shaped. In order to improve the sealing effect, a conventional non-illustrated sealing material, preferably a flat sealing strip, can be laid in the groove 47 and then compressed under the action of the projection or molding 46 on the frame 43 of the adjacent plate and thus tightly seal the gap between the two frames 43. In particular, when such an additional flat seal is used, it is not necessary for the frame 43 to be made of an elastic plastic.

Alternatively, a sealing material can be applied to the surface of the plate or frame during injection molding. Sealing grooves 27 are provided in the surface of the plate or frame in order to hold the sealing material.

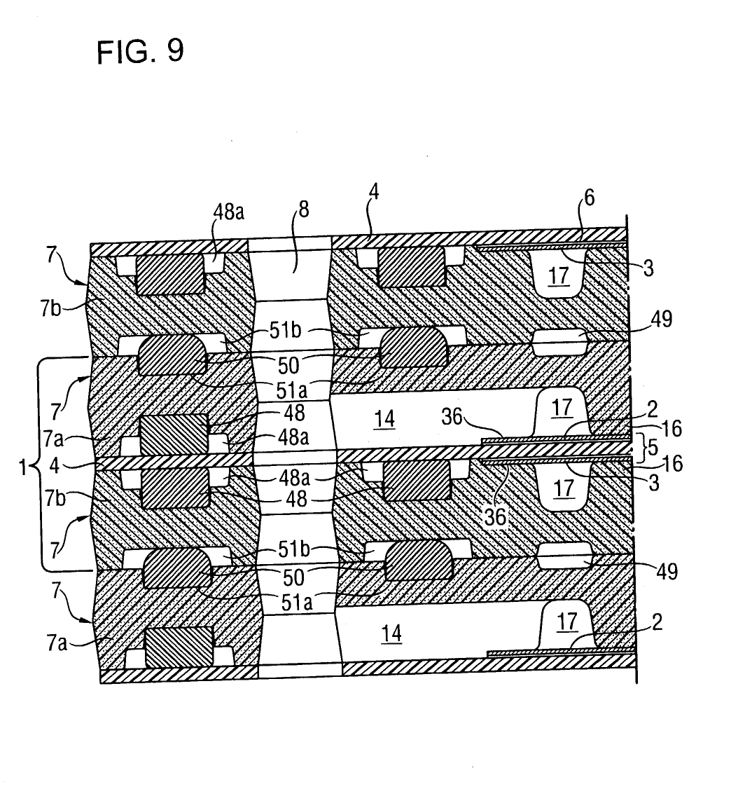

FIG. 9 shows a section of a stack of several fuel cells 1 in cross-section with exemplary embodiments of seals. The bipolar plates between the membrane electrode assemblies or MEAs 5 are formed as an assembly of two partial plates 7a, 7b having basic bodies. A fuel supply path 8 is shown as an example of the supply and discharge paths for the reaction and cooling media passing through the stack. The fuel supply path 8 is connected through at least one inlet 14 with the flow paths or channels 17 of the media distribution structure on the partial plate 7a on the anode side. Seals 48 seal the media distribution structure on the surface of the bipolar plate or BPP partial plates 7a, 7b facing the membrane electrode assembly MEA 5, against the supply and discharge paths for the other media passing through these plates. The electrodes 2, 3 are embedded in recesses 36. An edge area of the membrane 4 protrudes beyond the electrodes 2, 3. The seals 48 lie between the surface of a contact plate 7 and the adjacent membrane 4.

Electrolyte membranes in the present state of the art are highly sensitive to mechanical stress, for example from folding. Therefore, the seals 48 are preferably constructed to be flat to avoid such stressing of the membrane. A sealing groove 48a is constructed to be wider than the seal 48 in order to allow sideways expulsion of the sealing material upon compression of the seal 48.

If the bipolar plate or BPP 7 as shown in FIG. 9 is formed of anode and cathode partial plates 7a and 7b enclosing a coolant distribution structure 49 (cooling plate assembly), seals 50 are also required between these partial plates to seal the coolant distribution channels 49 and the supply and discharge paths of the other media against each other. Since the seal 50 does not touch the sensitive membrane but lies between two partial plates 7a and 7b, it is not necessary to construct the seal 50 to be flat.

In order to ensure that the residual wall thickness of the plate 7 in the area of the sealing groove 51 is not too small, in particular no thinner than the minimum value of 0.8 mm, it is advantageous if the seal 50 does not need to be received in its full height by just one of the two plates 7a and 7b.

Therefore, in adjacent plates, co-operating sealing grooves 51a and 51b are each provided with a part preferably having half the height required to hold the seal 51 in the compressed state. During production of the plate, the sealing groove 51a is completely filled in its width with the material of the seal 50 which in turn projects above the plate surface. When the partial plates 7a and 7b are joined, the protruding areas of the seal 50 are held by the co-operating sealing groove 51b. These sealing grooves 51b are wider than the seal 50 in the non-compressed state so that upon compression of the seal the surplus sealing material can be expelled sideways.

FIG. 9 shows a cooling plate assembly of the two partial plates 7a, 7b, having facing surfaces in which the coolant distribution channels are constructed perfectly mirror-image symmetrically. When the plates are stacked on each other, the coolant channels of the partial plates 7a and 7b lie precisely opposite each other and thus form the coolant distribution structure.

An alternative embodiment is for the coolant distribution structure 49 to be recessed only into one of the two partial plates while the adjacent surface of the other partial plate is flat and covers the channels on the one plate.

It is advantageous if the area of the plate on which the seal is to rest is made not of the graphite-plastic composite but of a sealing material of similar graphite-free plastic or plastic compatible with the sealing material. Due to the similarity between the two plastic materials, a better material joint can be achieved than between the plastic of the seal and the graphite of the conductive area. In order to construct the seal in this way advantageously as a plastic-plastic joint, it is necessary that the area of the contact plate on which the seal is to rest e.g. the frame, be formed of graphite-free plastic.

In embodiments of the contact plate according to the invention without a frame or edge area 43 of graphite-free plastic, the plate can also be formed from a graphite-plastic composite and the seal can be applied to the plate according to the invention in one mold in two component technology by injection molding. The transitions of the sealing grooves to the plate surface, as in the flow channels, are rounded to allow good filling of the injection molding with the graphite-plastic composite.

According to the invention, the plate with the media distribution and contact structure, optionally with a non-conductive area with further function elements including the seal, is produced in the injection molding process in one mold (multi-component process).

In order to provide for production of a conductive plate according to the invention with the structural features required for fuel cell operation as described above, from a composite of polypropylene and a mass percentage of 86% synthetic graphite with a plate surface of 140 mm×140 mm, a cycle time of 45 to 50 seconds is required. A conductivity transverse to the plate plane (through plane conductivity) of at least 20 S/cm, fulfils the requirements for fuel cell operation. Typical structure dimensions for the flow channels 17 are 0.6 to 0.8 mm (width and depth).

In order to reduce the contact resistance at the surfaces of the conductive plate, a surface layer which is a few micrometers thick, in which the plastic component of the composite is enriched, can be removed by treatment with an abrasive, for example by sandblasting.

We claim:

1. In an electrochemical cell having electrodes, a contact plate, comprising:
an injection molded basic body having a through plane conductivity of at least 20 S/cm;
said basic body formed of a plastic-graphite composite having a thermoplastic plastic component and a mass percentage of graphite of at least 70%;
said basic body having openings formed therein for supply paths and discharge paths of media reacting at the electrodes;
said basic body having at least one plate surface, a media distribution structure recessed in said plate surface defining flow paths for distribution of the medium reacting at adjacent electrodes, and a contact structure protruding from said media distribution structure with contact structure elements for providing electrical contact with an electrode adjacent said basic body;
connections between said media distribution structure on said plate surface and said supply path and discharge path for the media reacting at the adjacent electrodes;
said flow paths in said media distribution structure having base surfaces, wall surfaces and first transitions from said base surfaces to said wall surfaces, all of said first transitions being rounded; and
said contact structure elements having surfaces in contact with the adjacent electrodes, defining second transitions from said wall surfaces of said flow paths to said surfaces of said contact structure elements, all of said second transitions being rounded.

2. The contact plate according to claim 1, wherein said flow path has a given width, and said first transitions each have a radius of rounding of between at least one-tenth and at most half of said given width.

3. The contact plate according to claim 1, wherein said second transitions each have a radius of rounding of at least 0.1 mm and at most 0.5 mm.

4. A process for producing a contact plate for an electrochemical cell, which comprises:
providing said second rounded transitions of said contact structure elements according to claim 1 with a rounding radius;
constructing said contact structure elements with said second rounded transitions to be at least higher by said rounding radius than required for fitting in a cell stack; and
then reducing said contact structure elements by at least said rounding radius, for avoiding a loss of said surfaces of said contact structure elements.

5. The contact plate according to claim 1, wherein said flow paths in said media distribution structure have direction changes, and all of said direction changes are rounded.

6. The contact plate according to claim 1, wherein said at least one plate surface has grooves formed therein for holding seals.

7. The contact plate according to claim 1, wherein said at least one plate surface having said media distribution structure recessed therein has a recess formed therein for embedding an electrode.

8. A process for producing a contact plate for an electrochemical cell, which comprises:
injection molding said basic body according to claim 1, and bridging said openings with flow webs during the injection molding step.

9. The process according to claim 8, which further comprises removing the flow webs in a filled injection mold by injection stamping or core pulling.

10. A process for producing a contact plate for an electrochemical cell, which comprises:
producing said openings formed in said basic body according to claim 1 in a filled injection mold by injection stamping or core pulling.

11. The contact plate according to claim 1, wherein said basic body contains supporting webs bridging said openings.

12. The contact plate according to claim 11, wherein each of said supporting webs has a thickness of at least 0.8 mm and a rounded cross-section.

13. An injection mold for producing a contact plate for an electrochemical cell, comprising:
a gate formed as a sprue with a film gate, for producing said basic body according to claim 1.

14. The injection mold according to claim 13, wherein:
said basic body has a thickness and a width;
said film gate has a thickness of at least 0.3 mm and at most said thickness of said basic body; and
said film gate has a width of at least 5 mm and at most said width of said basic body.

15. An injection mold for producing a contact plate for an electrochemical cell, comprising:
a gate having hot channel nozzles with needle closures, for producing said basic body according to claim 1.

16. The injection mold according to claim 15, wherein each of said hot channel nozzles has a gate diameter of at least 5 mm.

17. The injection mold according to claim 15, which further comprises injection nozzles to be controlled in cascade.

18. The injection mold according to claim 15, wherein at least one gate channel has an opening recessed into said at least one plate surface of said basic body to be formed in the mold.

19. The contact plate according to claim 1, wherein said basic body has an edge with at least one bulge as an auxiliary surface for positioning gate channels.

20. The contact plate according to claim 1, wherein said basic body has a plane and surfaces running transverse to said plane, all of said surfaces running transverse to said plane having a slope of 0.5 to 30° relative to a normal to said at least one plate surface of said basic body.

21. An injection mold for producing a contact plate for an electrochemical cell, comprising:
ejector pins impacting on a base of sealing grooves formed in said basic body according to claim 1 for removal of said basic body from the mold.

22. An injection mold for producing a contact plate for an electrochemical cell, comprising:
two mold halves defining a parting surface therebetween; and
rectangular ejectors having reliefs engaging behind said basic body and protruding at a front surface of said basic body over said parting surface, for removal of said basic body according to claim 1 from the mold.

23. An injection mold for producing a contact plate for an electrochemical cell, comprising:
compressed air ejectors for removal of said basic body according to claim 1 from the mold, said compressed air ejectors having compressed air channels with openings lying on said base surfaces of said flow paths of said media distribution structure.

24. The contact plate according to claim 1, wherein said thermoplastic is polypropylene.

25. The contact plate according to claim 1, wherein said mass percentage of graphite is at least 86%.

26. The contact plate according to claim 1, wherein said basic body has only one surface with said media distribution structure.

27. The contact plate according to claim 26, wherein the plate is an end plate of a stack of electrochemical cells.

28. The contact plate according to claim 1, which further comprises another media distribution structure, said at least one plate surface being two plate surfaces each having a respective one of said media distribution structures.

29. The contact plate according to claim 28, wherein said basic body has a thickness between said base surfaces of said flow paths of said media distribution structures on said plate surfaces of at least 0.8 mm.

30. The contact plate according to claim 28, wherein the electrodes are an anode and a cathode, said media distribution structure on one of said plate surfaces serves for distribution of a medium reacting at the anode and said media distribution structure on the other of said plate surfaces serves for distribution of a medium reacting at the cathode.

31. The contact plate according to claim 28, where the plate is a bipolar plate in a stack of electrochemical cells.

32. The contact plate according to claim 28, wherein said media distribution structure on one of said plate surfaces serves to distribute a medium reacting at one of the electrodes and said media distribution structure on the other of said plate surfaces serves for distribution of a coolant.

33. A contact plate assembly, comprising:
two of said basic bodies according to claim 1;
one of said basic bodies having another media distribution structure, said at least one plate surface being two plate surfaces each having a respective one of said media distribution structures, said media distribution structure on one of said plate surfaces serving to distribute a medium reacting at one of the electrodes and said media distribution structure on the other of said plate surfaces serving as a coolant distribution structure;
the other of said basic bodies having only one surface with said media distribution structure and another surface with no media distribution structure; and
said other surface of said one basic body with said coolant distribution structure being adjacent said other surface of said other basic body containing no media distribution structure.

34. A contact plate assembly, comprising:
two of said basic bodies according to claim 32;
said two plate surfaces each having one of said coolant distribution structures being mutually adjacent, said channels of said coolant distribution structure in said basic bodies being mirror-image symmetrical, and said channels lying mutually opposite in said basic bodies forming said coolant distribution structures.

35. The assembly according to claim 33, wherein the contact plate assembly is a cooling plate assembly in a stack of electrochemical cells.

36. The assembly according to claim 34, wherein the contact plate assembly is a cooling plate assembly in a stack of electrochemical cells.

37. An end plate, comprising a contact plate according to claim 1.

38. A bipolar plate, comprising a contact plate according to claim 1.

39. A cooling plate assembly in a stack of fuel cells of the polymer-electrolyte fuel cell type, comprising contact plates according to claim 1.

40. In an electrochemical cell having electrodes, a contact plate, comprising:
a basic body;
said basic body including a conductive area having a through plane conductivity of at least 20 S/cm and being formed of a plastic-graphite composite;
said basic body including a non-conductive edge area adjacent said conductive area;
said basic body having openings formed therein for supply paths and discharge paths of media reacting at the electrodes, said openings being integrated in said non-conductive edge area; and
said basic body including said conductive area and said non-conductive edge area being injection molded in one mold by multi-component technology.

41. In an electrochemical cell having electrodes, a contact plate, comprising:
a basic body;
said basic body including a conductive area having a through plane conductivity of at least 20 S/cm and being formed of a plastic-graphite composite;
said basic body including a non-conductive edge area adjacent said conductive area;
said basic body having a plate surface, a media distribution structure on said plate surface, and connections between said media distribution structure and a supply path and a discharge path for a medium reacting at an electrode adjacent the plates, said connections being integrated in said non-conductive edge area; and
said basic body including said conductive area and said non-conductive edge area being injection molded in one mold by multi-component technology.

42. In an electrochemical cell having electrodes, a contact plate, comprising:
a basic body;
said basic body including a conductive area having a through plane conductivity of at least 20 S/cm and being formed of a plastic-graphite composite;
said basic body including a non-conductive edge area adjacent said conductive area;
said basic body having sealing grooves formed therein, said sealing grooves being integrated in said non-conductive edge area; and
said basic body including said conductive area and said non-conductive edge area being injection molded in one mold by multi-component technology.

43. In an electrochemical cell having electrodes, a contact plate, comprising:
a basic body;
said basic body including a conductive area having a through plane conductivity of at least 20 S/cm and being formed of a plastic-graphite composite;
said basic body including a non-conductive edge area adjacent said conductive area;
said basic body having an element fulfilling a sealing function, said element being integrated in said non-conductive edge area; and
said basic body including said conductive area and said non-conductive edge area being injection molded in one mold by multi-component technology.

44. In an electrochemical cell having electrodes, a contact plate, comprising:
a basic body;
said basic body including a conductive area having a through plane conductivity of at least 20 S/cm and being formed of a plastic-graphite composite;
said basic body including a non-conductive edge area adjacent said conductive area;
said basic body having openings formed therein for supply paths and discharge paths for media reacting at the electrodes;
said basic body having a plate surface, a media distribution structure on said plate surface, and connections between said media distribution structure, said supply path and said discharge path for the media reacting at an electrode adjacent the plate;
said basic body having sealing grooves formed therein; and said basic body having an element fulfilling a sealing function, said element being integrated in said non-conductive edge area; and
said basic body including said conductive area and said non-conductive edge area being injection molded in one mold by multi-component technology.

45. The contact plate according to claim 40, wherein said non-conductive edge area is a frame fully surrounding said conductive area, and said frame has sides with equal widths.

46. The contact plate according to claim 41, wherein said non-conductive edge area is a frame fully surrounding said conductive area, and said frame has sides with equal widths.

47. The contact plate according to claim 42, wherein said non-conductive edge area is a frame fully surrounding said conductive area, and said frame has sides with equal widths.

48. The contact plate according to claim 43, wherein said non-conductive edge area is a frame fully surrounding said conductive area, and said frame has sides with equal widths.

49. The contact plate according to claim 44, wherein said non-conductive edge area is a frame fully surrounding said conductive area, and said frame has sides with equal widths.

50. The contact plate according to claim 40, wherein said non-conductive edge area is a frame fully surrounding said conductive area, and said frame has sides with different widths.

51. The contact plate according to claim 41, wherein said non-conductive edge area is a frame fully surrounding said conductive area, and said frame has sides with different widths.

52. The contact plate according to claim 42, wherein said non-conductive edge area is a frame fully surrounding said conductive area, and said frame has sides with different widths.

53. The contact plate according to claim 43, wherein said non-conductive edge area is a frame fully surrounding said conductive area, and said frame has sides with different widths.

54. The contact plate according to claim 44, wherein said non-conductive edge area is a frame fully surrounding said conductive area, and said frame has sides with different widths.

55. The contact plate according to claim 40, wherein said non-conductive edge area partially surrounds said conductive area.

56. The contact plate according to claim 41, wherein said non-conductive edge area partially surrounds said conductive area.

57. The contact plate according to claim 42, wherein said non-conductive edge area partially surrounds said conductive area.

58. The contact plate according to claim 43, wherein said non-conductive edge area partially surrounds said conductive area.

59. The contact plate according to claim 44, wherein said non-conductive edge area partially surrounds said conductive area.

60. The contact plate according to claim 40, wherein said non-conductive edge area and said conductive area are formed of materials having an interference connection therebetween.

61. The contact plate according to claim 41, wherein said non-conductive edge area and said conductive area are formed of materials having an interference connection therebetween.

62. The contact plate according to claim 42, wherein said non-conductive edge area and said conductive area are formed of materials having an interference connection therebetween.

63. The contact plate according to claim 43, wherein said non-conductive edge area and said conductive area are formed of materials having an interference connection therebetween.

64. The contact plate according to claim 44, wherein said non-conductive edge area and said conductive area are formed of materials having an interference connection therebetween.

65. The contact plate according to claim 40, which further comprises interference structures formed between said non-conductive edge area and said conductive area to allow for a connection selected from the group consisting of interference connection, engagement, interlocking and intermeshing.

66. The contact plate according to claim 41, which further comprises interference structures formed between said non-conductive edge area and said conductive area to allow for a connection selected from the group consisting of interference connection, engagement, interlocking and intermeshing.

67. The contact plate according to claim 42, which further comprises interference structures formed between said non-conductive edge area and said conductive area to allow for a connection selected from the group consisting of interference connection, engagement, interlocking and intermeshing.

68. The contact plate according to claim 43, which further comprises interference structures formed between said non-conductive edge area and said conductive area to allow for a connection selected from the group consisting of interference connection, engagement, interlocking and intermeshing.

69. The contact plate according to claim 44, which further comprises interference structures formed between said non-conductive edge area and said conductive area to allow for a connection selected from the group consisting of interference connection, engagement, interlocking and intermeshing.

70. The contact plate according to claim 40, wherein said basic body has a plate surface, an electrolyte membrane and the electrodes form a membrane electrode assembly, and said non-conductive edge area is a frame formed of an elastomer protruding over said plate surface far enough to sealingly surround said membrane electrode assembly in a compressed state, in co-operation with a similarly shaped frame of a following contact plate.

71. The contact plate according to claim 41, wherein an electrolyte membrane and the electrodes form a membrane electrode assembly, and said non-conductive edge area is a frame formed of an elastomer protruding over said plate surface far enough to sealingly surround said membrane electrode assembly in a compressed state, in co-operation with a similarly shaped frame of a following contact plate.

72. The contact plate according to claim 42, wherein said basic body has a plate surface, an electrolyte membrane and the electrodes form a membrane electrode assembly, and said non-conductive edge area is a frame formed of an elastomer protruding over said plate surface far enough to sealingly surround said membrane electrode assembly in a compressed state, in co-operation with a similarly shaped frame of a following contact plate.

73. The contact plate according to claim 43, wherein said basic body has a plate surface, an electrolyte membrane and the electrodes form a membrane electrode assembly, and said non-conductive edge area is a frame formed of an elastomer protruding over said plate surface far enough to sealingly surround said membrane electrode assembly in a compressed state, in co-operation with a similarly shaped frame of a following contact plate.

74. The contact plate according to claim 44, wherein an electrolyte membrane and the electrodes form a membrane electrode assembly, and said non-conductive edge area is a frame formed of an elastomer protruding over said plate surface far enough to sealingly surround said membrane electrode assembly in a compressed state, in co-operation with a similarly shaped frame of a following contact plate.

75. The contact plate according to claim 40, wherein said non-conductive edge area is a frame having one surface with a peripheral tongue and another surface with a peripheral groove, and said tongues and grooves of successive frames intermesh as a tongue and groove connection upon compression of several cells into a cell stack.

76. The contact plate according to claim 41, wherein said non-conductive edge area is a frame having one surface with a peripheral tongue and another surface with a peripheral groove, and said tongues and grooves of successive frames intermesh as a tongue and groove connection upon compression of several cells into a cell stack.

77. The contact plate according to claim 42, wherein said non-conductive edge area is a frame having one surface with a peripheral tongue and another surface with a peripheral groove, and said tongues and grooves of successive frames intermesh as a tongue and groove connection upon compression of several cells into a cell stack.

78. The contact plate according to claim 43, wherein said non-conductive edge area is a frame having one surface with a peripheral tongue and another surface with a peripheral groove, and said tongues and grooves of successive frames intermesh as a tongue and groove connection upon compression of several cells into a cell stack.

79. The contact plate according to claim 44, wherein said non-conductive edge area is a frame having one surface with a peripheral tongue and another surface with a peripheral groove, and said tongues and grooves of successive frames intermesh as a tongue and groove connection upon compression of several cells into a cell stack.

80. The contact plate according to claim 40, wherein said groove contains an inlaid sealing strip.

81. The contact plate according to claim 41, wherein said groove contains an inlaid sealing strip.

82. The contact plate according to claim 42, wherein said groove contains an inlaid sealing strip.

83. The contact plate according to claim 43, wherein said groove contains an inlaid sealing strip.

84. The contact plate according to claim 44, wherein said groove contains an inlaid sealing strip.

85. The contact plate according to claim 1, wherein said basic body has an injection-molded seal.

86. The contact plate according to claim 40, wherein said basic body has an injection-molded seal.

87. The contact plate according to claim 41, wherein said basic body has an injection-molded seal.

88. The contact plate according to claim 42, wherein said basic body has an injection-molded seal.

89. The contact plate according to claim 43, wherein said basic body has an injection-molded seal.

90. The contact plate according to claim 44, wherein said basic body has an injection-molded seal.

91. The contact plate according to claim 85, wherein an electrolyte membrane is disposed between the electrodes, and flat seals are disposed between the electrolyte membrane and said plate surface.

92. The contact plate according to claim 86, wherein an electrolyte membrane is disposed between the electrodes, and flat seals are disposed between the electrolyte membrane and said plate surface.

93. The contact plate according to claim 87, wherein an electrolyte membrane is disposed between the electrodes, and flat seals are disposed between the electrolyte membrane and said plate surface.

94. The contact plate according to claim 88, wherein an electrolyte membrane is disposed between the electrodes, and flat seals are disposed between the electrolyte membrane and said plate surface.

95. The contact plate according to claim 89, wherein an electrolyte membrane is disposed between the electrodes, and flat seals are disposed between the electrolyte membrane and said plate surface.

96. The contact plate according to claim 90, wherein an electrolyte membrane is disposed between the electrodes, and flat seals are disposed between the electrolyte membrane and said plate surface.

97. A contact plate assembly according to claim 33, wherein said basic bodies are mutually adjacent, and a seal is disposed between said basic bodies and held by co-operating sealing grooves formed in said basic bodies.

98. A contact plate assembly according to claim 34, wherein said basic bodies are mutually adjacent, and a seal is disposed between said basic bodies and held by co-operating sealing grooves formed in said basic bodies.

99. The contact plate according to claim 6, wherein said grooves are sealing grooves holding said seals and being wider than said seals in a non-compressed state.

100. The contact plate according to claim 42, which further comprises seals held by said sealing grooves, said sealing grooves being wider than said seals in a non-compressed state.

101. The contact plate according to claim 44, which further comprises seals held by said sealing grooves, said sealing grooves being wider than said seals in a non-compressed state.

102. A process for producing a contact plate for an electrochemical cell, which comprises:
removing a layer being at most 30 μm thick from a surface of said conductive area according to claim 40 by treatment with an abrasive.

103. A process for producing a contact plate for an electrochemical cell, which comprises:
removing a layer being at most 30 μm thick from a surface of said conductive area according to claim 41 by treatment with an abrasive.

104. A process for producing a contact plate for an electrochemical cell, which comprises:
removing a layer being at most 30 μm thick from a surface of said conductive area according to claim 42 by treatment with an abrasive.

105. A process for producing a contact plate for an electrochemical cell, which comprises:
removing a layer being at most 30 μm thick from a surface of said conductive area according to claim 43 by treatment with an abrasive.

106. A process for producing a contact plate for an electrochemical cell, which comprises:
removing a layer being at most 30 μm thick from a surface of said conductive area according to claim 44 by treatment with an abrasive.
